(19) United States
(12) Patent Application Publication
(10) Pub. No.: US 2016/0126715 A1
(43) Pub. Date: May 5, 2016

(54) Plenum Seal Apparatus

(71) Applicant: Audix Corporation, Wilsonville, OR (US)

(72) Inventor: Fred Bigeh, Wilsonville, OR (US)

(21) Appl. No.: 14/530,923

(22) Filed: Nov. 3, 2014

(51) Int. Cl. H02G 15/013; H01R 43/26; H02G 1/08; H01R 24/64; H02G 3/22

(52) U.S. Cl. CPC H02G 15/013; H01R 24/64; H02G 3/22; H02G 1/08; H01R 43/26

(57) ABSTRACT

A plenum seal apparatus is defined by a plenum cap and a base adaptor that is attached to a barrier between adjacent spaces and to which the cap is attached. A cable extends across the barrier and the plenum seal apparatus creates a plenum seal around the cable and between the spaces. The plenum cap includes an O-ring for sealing engagement with the cable and an open cavity within the cap in which a standard plug connector resides.

### TECHNICAL FIELD

The present invention relates to apparatus used to create or maintain a seal across an interconnection between a cable and a base member, and more particularly to an adaptor for receiving a cable such as is used with a registered jack style of connector where the cable extends through a wall, ceiling or other barrier where a plenum seal needs to be created and maintained.

### BACKGROUND

Wired microphones require a cable that electrically connects the microphone to the electronics that power and control the microphone. Often, the cabling that connects the mic to the electronics creates difficulties in both positioning the mic in desired locations, and in routing the cable. For instance, if the mic is suspended by the cable and the user wants it in any orientation other than vertical, the cable tends to spin, making precise directional control difficult. The cable routing is also a problem in many installations. Thus, in many localities building codes, fire codes and similar ordinances place specific requirements for creating a plenum between the living or working space and the space above a drop ceiling. When the microphone cable is extended through the drop ceiling, the cable may destroy the plenum rating of the installation by creating a passageway from the occupied space to the space above the drop ceiling. In order to maintain the plenum rating, the opening through the ceiling where the cable extends through the ceiling is often sealed to prevent passing of air through the opening. Alternately, the cable may be run under the ceiling rather than passing it through the ceiling. This tends to be unsightly.

With existing wired microphones that have the cable extending through the ceiling with a sealed opening, the length of the cable cannot be readily adjusted below the ceiling. Therefore, changing the length of the cable to reposition the mic (both in terms of dimension and directional position) requires of the mic requires that the cable is cut, extra cable added to adjust the length, and the electronics reconnected. If the cable is shortened, the coiled up cable can get in the way and is unsightly.

There is a need therefore for apparatus that facilitates adjustment of wired microphones without destroying plenum ratings. The specific type of wiring or cabling will depend upon the types of equipment that are being wired. A very common type of cabling connection that is used in a variety of settings are the “registered jack”—“RJ”—types of connectors. These connectors are standardized physical network interfaces for connecting telecommunications or data equipment. There are many different standard designs for RJ connectors such as RJ11, RJ14, RJ21, RJ35, RJ45, Rj48 and numerous others. For purposes here, RJ connectors include a male plug attached to one end of a cable that leads to, for example, an electronic device of some kind, and a female plug attached to one end of the cable to which the electronic device is to be connected and which leads to, for example, a service provided by a local exchange carrier. The female connector typically terminates at a wall or ceiling plate that is supported by some kind of a junction box in the wall or ceiling and the cable extends from the female connector.

The standard RJ setup just described does not contemplate any seal between the male and female ends of the connectors and as such, cannot provide a plenum seal between the spaces separated by the wall or ceiling barrier. As such, where there is a desire or need to maintain a plenum seal across the barrier the RJ type of connectors present a plenum-seal-destroying problem. There is a need, therefore, for apparatus that allows a plenum seal where barrier-penetrating connectors such as RJ connectors are used.

The present invention comprises a plenum seal apparatus. The apparatus is defined by a cap and an adaptor to which the cap is attached that address the shortcomings of prior systems and allows for the creation and maintenance of a plenum seal at the junction between cable ends that are attached with connectors such as the RJ connectors. The plenum seal creates and defines an air-tight seal between the cabling and the cap to maintain a plenum between adjacent spaces on either side of a barrier such as a wall or ceiling. As used herein, therefore, the term plenum seal refers to apparatus that creates and maintains an air-tight seal across a barrier between adjacent spaces where cabling extends through the barrier.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective exploded view of a first embodiment of a cable microphone adaptor according to the present invention, illustrating the adaptor from an angle that shows one side of the components of the adaptor.

FIG. 2 is a perspective view of the adaptor shown FIG. 1 but showing the adaptor from an angle that shows the components of the adaptor from the opposite side of the components from the view of FIG. 1.

FIG. 3 is a side elevation and cross sectional view of the assembled adaptor according to the present invention to illustrate the internal structures. In FIG. 3 the cap has been tightened so that the microphone cable is immovably secured in the adaptor.

FIG. 4 is a side elevation and cross sectional view of the assembled adaptor similar to the view of FIG. 3, but in FIG. 4 the cap has been loosened so that the microphone cable is movable relative to the adaptor as illustrated with the arrows A and B.

FIG. 5 is a close up view of a second embodiment of an adaptor according to the present invention, showing the adaptor components in a partially assembled condition.

FIG. 6 is a perspective view of a third embodiment of an adaptor according to the present invention, showing the adaptor assembled and a microphone attached to the microphone cable.

FIG. 7 is a perspective view of the adaptor shown in FIG. 6, with the adaptor extending through a ceiling tile so that just the external portion of the adaptor and microphone cable are in the view

FIG. 8 is a perspective view of the installation of FIG. 7, showing the microphone on the microphone cable

FIG. 9 is a perspective view of the adaptor of FIG. 1 with the adaptor installed in a junction box.

FIG. 10 is a perspective view of the junction box seen in FIG. 7 with a second adaptor of the type shown in FIG. 6 extending through the underlying ceiling and into the junction box.

FIG. 11 is perspective and exploded view of a plenum seal apparatus according to an embodiment of the invention and for use with through-barrier cabling that uses connectors such as the registered jack type of connectors.

FIG. 12 is an elevation view taken from the interior of a junction box of the plenum seal apparatus illustrated in FIG. 11, with the cabling and female end of the plug not shown.

FIG. 13 is a perspective exploded view of the plenum cap according to the embodiment illustrated in FIG. 11.

FIG. 14 is a side sectional and partially exploded view of the embodiment shown in FIG. 11, illustrating the apparatus with the male and female couplers attached but with the components of the plenum seal apparatus not fully connected.

FIG. 15 is a side sectional view of the components shown in FIG. 14 in a fully assembled condition so as to create and maintain a plenum seal.

### DETAILED DESCRIPTION OF ILLUSTRATED EMBODIMENTS

The invention will now be described in detail with reference to the drawings. It will be understood that relative directional terms are used at times to describe components of the invention and relative positions of the parts. As a naming convention, the plane of the floor in a living or work space is considered to be a generally horizontal surface. The ceiling is a plane that in most installations is parallel to the floor, though not always. Other relative directional terms correspond to this convention: “upper” refers to the direction above and away from the ground plane; “lower” is generally in the opposite direction, “inward” is the direction from the exterior toward the interior of the adaptor, “vertical” is the direction normal to the horizontal ground plane, and so on.

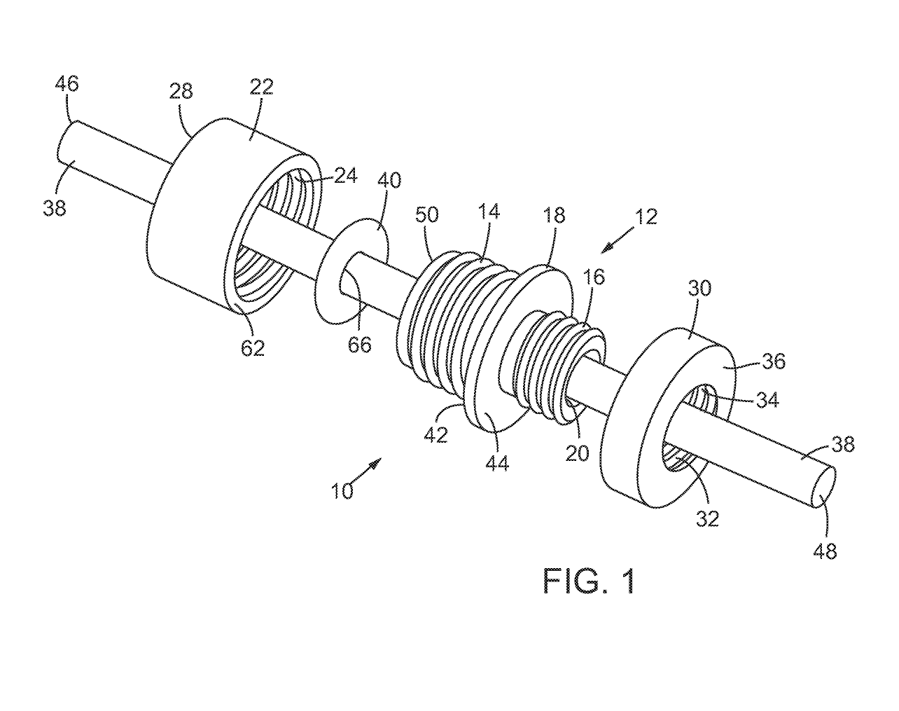

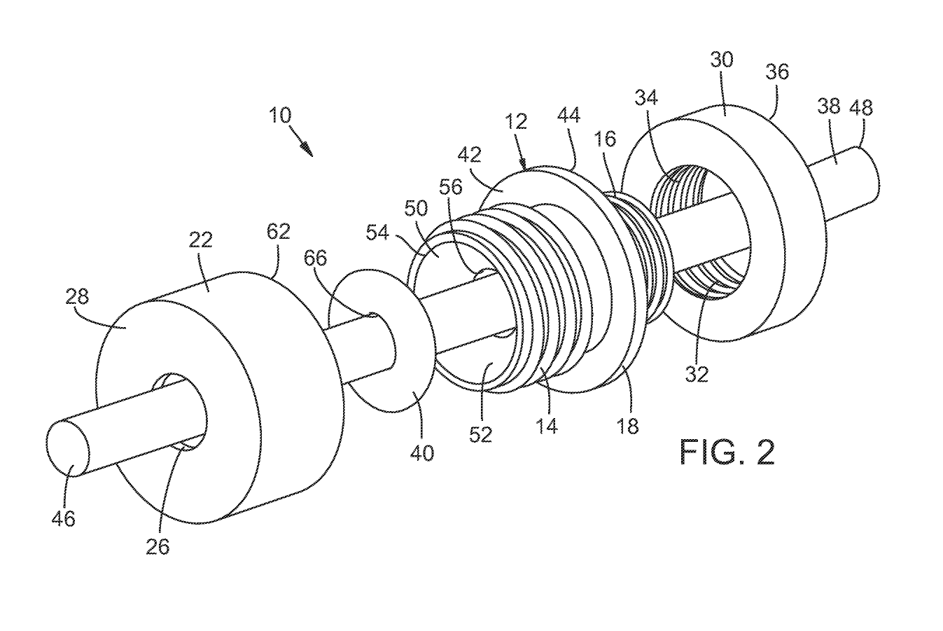

Turning now to the drawings, a first embodiment of an adaptor 10 is shown in FIGS. 1 and 2. The adaptor 10 comprises a main body 12 having a first threaded end 14 and an opposite second threaded end 16 with a circumferential flange 18 separating the first and second threaded ends and extending from the main body 12. A bore 20 extends longitudinally through main body 12. A cap 22 has an internally threaded interior 24 and a bore 26 through the outer end 28 of the cap. Cap 22 threads onto first threaded end 14. A nut 30 has an internally threaded interior 32 and a bore 34 through the outer end 36 of the nut. Nut 30 threads onto second threaded end 16.

A microphone cable 38 extends through bore 26 in cap 22, bore 20 through main body 12 and bore 34 in nut 36. An O-ring 40 is captured between cap 22 and main body 12 as detailed below and the cable 38 extends through the central opening 66 in O-ring 40. The O-ring is a pliable material such as rubber and the diameter of central opening 66 of the O-ring is just slightly larger than the outer diameter of mic cable 38 so that the mic cable is easily inserted through the central opening of the O-ring.

In the assembled adaptor, with cable 38 extending through the bores through the components just described, cap 22 threads onto main body 12 with the threaded interior 24 of the cap threaded onto first threaded end 14, and with O-ring 40 between the cap and the main body. On the opposite end of the main body 12, the threaded interior 32 of nut 30 is threaded onto second threaded end 16 of main body 12.

Circumferential flange 18 has opposite flattened sides which are referred to herein as “adjustment side” 42 and the opposite, “fixing side” 44. As detailed below, adaptor 10 is designed to extend through a bore in a surface such as a ceiling, a wall, or a wall of a junction box to give a few examples. The size of the bore through the wall is greater than the size of the seconded threaded end 16 but less than the diameter of flange 18. When adaptor 10 is assembled, the second threaded end 16 is inserted through such a bore until the fixing side 44 of the flange 18 abuts the outer surface of the wall. For example, if the adaptor is installed through a bore in a ceiling tile, the second threaded end 16 is pushed through the bore in the tile until the fixing side of the flange 18 butts against the ceiling tile with the fixing side 44 of flange 18 pressed against the room-facing side of the tile. On the opposite side of the tile—that is, the side of the tile above the living space, in the plenum space, the nut 30 is threaded onto the second threaded end 16 to fix the main body 12 to the tile. The adjustment side 42 of the flange 18 thus faces toward the living-space below the ceiling tile. Typically, a microphone is attached to the end 46 of the microphone cable 38 while the opposite end 48 is attached to other electronics.

FIG. 2 is an exploded view similar to FIG. 1 except showing the components described above from the opposite angle. In this view it may be seen that main body 12 has an opening 50 interiorly of first threaded end 14 and that the wall 52 of the opening 50 angles or slopes inwardly toward the center of the main body. In other words, the diameter of opening 50 at the outermost edge 54 of the main body 12 is greater than the diameter of the opening moving in the direction toward the center of the main body—to the right in the view of FIG. 2 to define a frusto-conically shaped surface. The diameter of opening 50 at the outermost edge 54 of the main body 12 is roughly the same as the outer diameter of O-ring 40. Moving toward the center of the main body, the diameter of opening 50 near the center 56 is less than the diameter of O-ring 40.

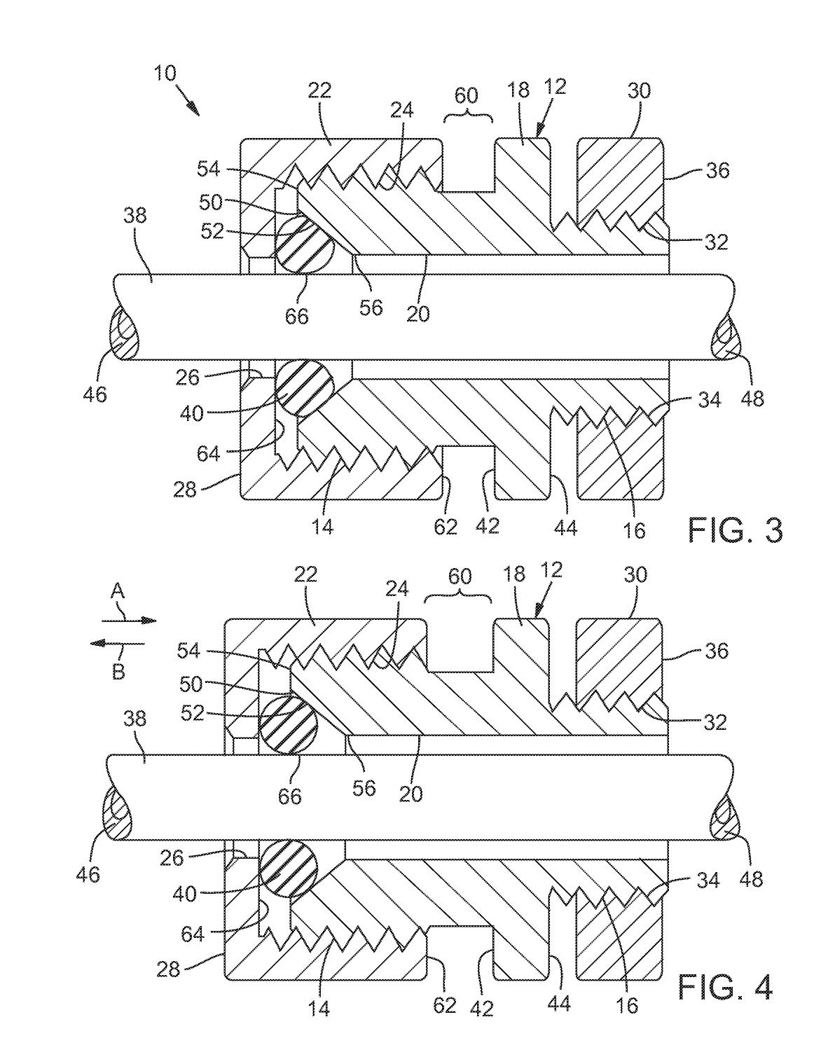

In FIGS. 3 and 4 the components described above and shown in FIGS. 1 and 2 are shown assembled. Thus, the cable 38 is extended through the components and the cap 22 is threaded onto first threaded end 14 of main body 12, and nut 30 is threaded onto second threaded end 16 of the main body. In FIG. 3 there is a space 60 between adjustment side 42 of flange 18 and the nearest, facing edge 62 of cap 22. This space allows for adjustment of the cap 22 on the threaded end 14—tightening and loosening the cap relative to the main body.

In FIG. 3, nut 22 is threaded tightly onto first threaded end 14 of main body 12. As the nut is threaded inwardly onto main body 12, O-ring 40 is forced inwardly in opening 50 so that the outer surface of the O-ring is forced along the narrowing sloped wall 52—the O-ring is pushed to the right in the view of FIG. 3 by the interior wall 64 of nut 22 that surrounds opening 26. As the O-ring 40 is forced into the gradually narrowing opening 50 and down the sloped wall 52, the O-ring 40 is compressed axially inwardly toward the center of opening 66 of the O-ring. As the O-ring thus compresses, the interior opening 66 of the O-ring is compressed tightly around cable 38. As this happens the O-ring compresses against the cable, capturing the cable 38 and making movement of cable 38 through adaptor 10 very difficult and thereby fixing the cable relative to the main body. Stated another way, when cap 22 is tightened onto main body 12, the cable is captured by the compression of the O-ring 40, which is compressed between interior wall 64, the sloping walls of opening 50, and the cable 38, so that relative movement between the cable 38 and the adaptor 10 is prevented (although the compressive capture of the cable by the O-ring may be overcome by pulling very forcibly on the cable 38, the amount of force required depending of course on the tightness of the cap on main body 12). As detailed below, when the cap 22 is tightened onto main body 12, there is an airtight seal formed through bore 20.

FIG. 4 illustrates loosening of cap 22 from its locked position shown in FIG. 3. In FIG. 4, cap 22 has been loosed from main body 12. As cap 22 is loosened on first threaded end 14, this causes decompression of O-ring 40 as the nut moves away from the flange 18 and concomitant lessening of the compression between O-ring 40 and cable 38. The space 60 in FIG. 4 is greater than the analogous space 60 in FIG. 3. This loosening of cap 22 releases the engagement between O-ring 40 and cable 38 and thus allows the cable 38 to be moved relative to the adaptor 10 in both directions as shown by arrows A and B.

This allows for simple repositioning of the microphone (which is attached to end 46 of the cable). Moreover, with cap 22 loosened from its locked or tightened position of FIG. 3, the cable 38 may be axially rotated relative to the main body 12. Rotation may be 360 degrees or more in either direction relative to the main body. This allows for increased ability to point the microphone in the desired direction. For example, if the microphone (or several microphones) are suspended from the ceiling over a conference table, the height of the mics relative to the table (i.e., arrows A and B) can be easily adjusted, and rotation of the cables and mics relative to the adaptor 10 allows the user to “point” the mics toward the desired sound source (e.g., people speaking) or away from unwanted sound sources (e.g., TV speakers, HVAC vents, etc.).

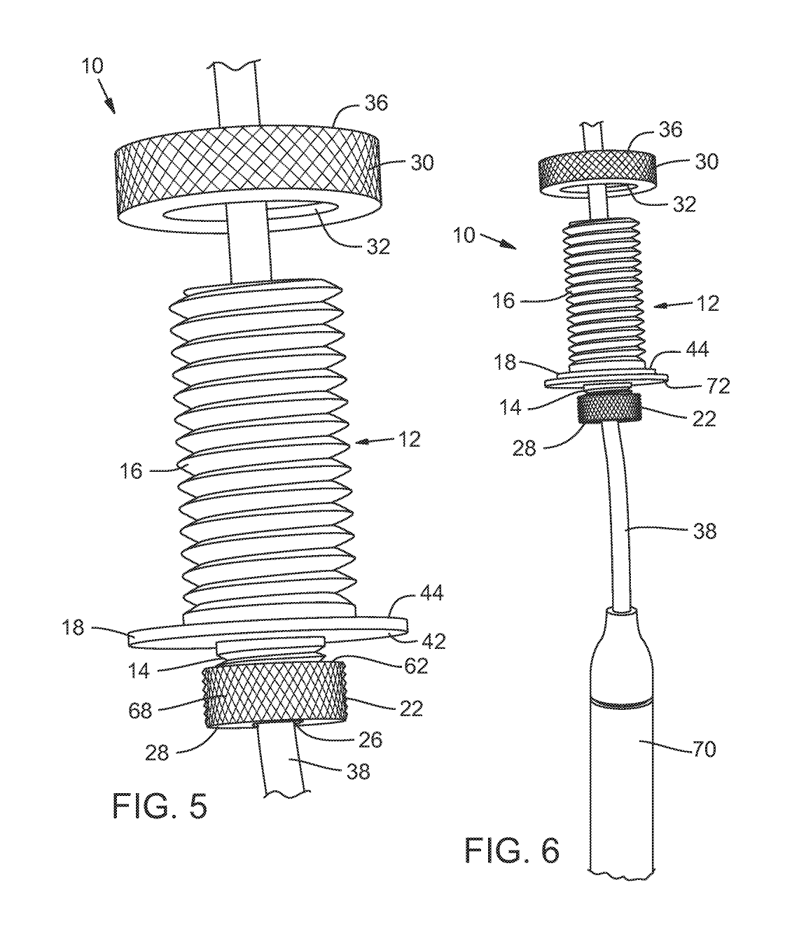

In FIG. 5 a second embodiment of an adaptor 10 according to the present invention is illustrated. Here, the second threaded end 16 of main body 12 is relatively larger and relatively longer than the first threaded end 14 and the nut 30 is shown spaced apart from the main body—that is, not threaded onto threaded end 16. This embodiment includes a cap 22 with a knurled surface 68. This embodiment would be used where the bore through which the main body is inserted in an installation is of larger size than the embodiment of FIGS. 1 through 4. It will also be appreciated that the second threaded end 16 may have one flattened side so that in cross section the threaded barrel is D-shaped rather than round. In this instance the second threaded end may be inserted through a bore that has a like D-shape in a wall or other surface. The mating D-shaped parts prevent rotation of the main body 12 relative to the surface.

An adaptor 10 is shown with a microphone 70 on cable 30 in FIG. 6. In this embodiment, a finishing flange 72 is used between cap 22 and flange 18 to provide a finished appearance.

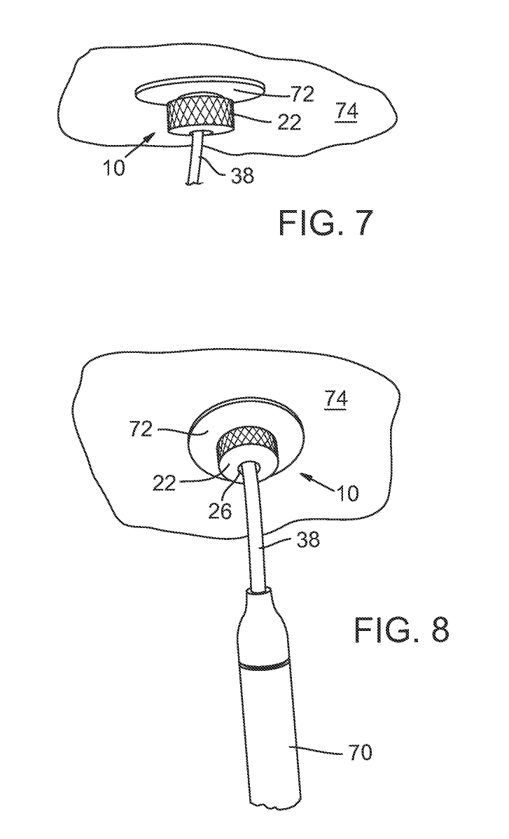

The embodiment of FIG. 6 is shown installed in a ceiling tile 74 in FIGS. 7 and 8. The finishing flange 72 provides a clean and finished appearance for the adaptor 10 on the interior-facing side of the ceiling tile 74.

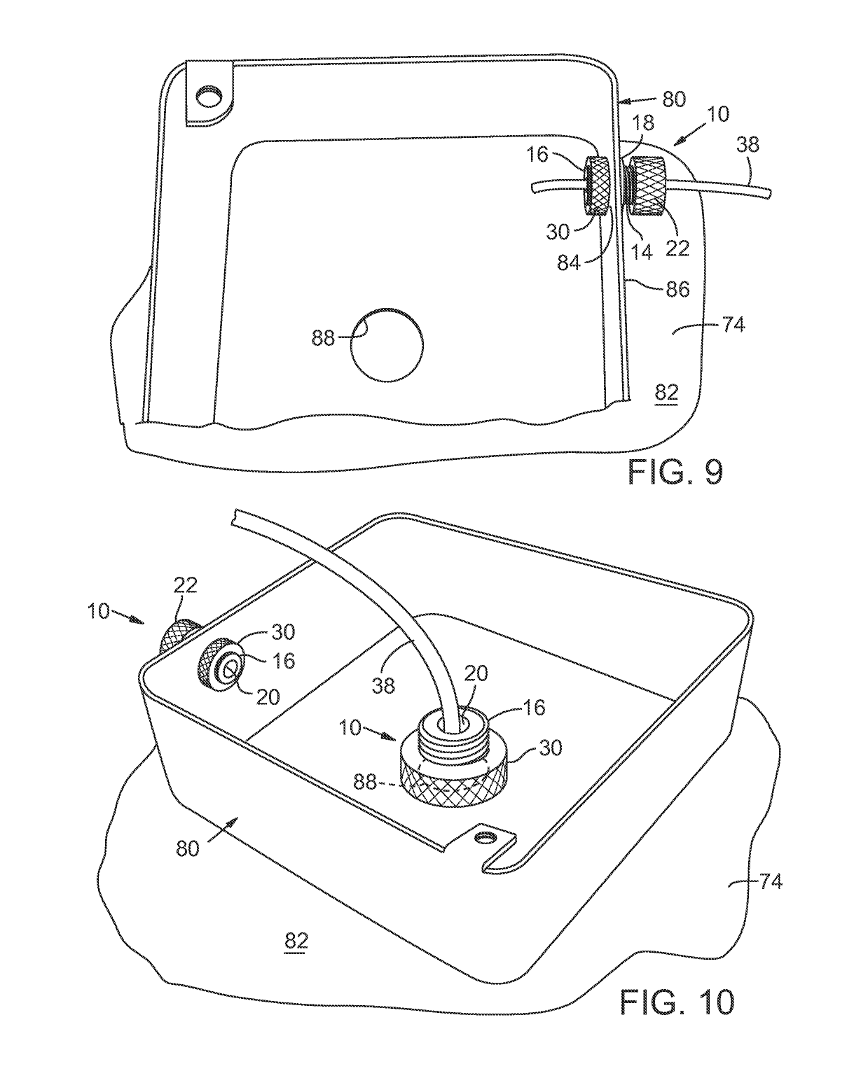

Turning now to FIG. 9, an adaptor 10 is shown as used with a junction box 80 that is shown attached to a surface 82, which in this instance is the upper surface of a ceiling tile such as ceiling tile 74 of FIG. 5. The “upper surface” 82 of the ceiling tile 74 is the surface of the tile that is above the room over which the tile is installed. In other words, the upper surface is the surface opposite the interior-facing surface shown in FIGS. 7 and 8. As may be seen the second threaded end 16 of main body 12 extends through a bore 84 in a wall 86 of junction box 80, which as noted above may be D-shaped when the second threaded end 16 is also D-shaped. The main body 12 is securely attached to wall 86 with nut 30, which when tightened captures the wall 86 around the bore 84 between the fixing surface 44 of flange 18 and the nut 30 (i.e., the portion of wall 86 immediately surrounding the bore 84 is captured between the nut and the flange—when the nut is tightened it secures adaptor 10 securely to the junction box). There is a bore 88 in the wall of the junction box 80 that rests against the surface 82 of ceiling tile 74.

In FIG. 10 a second adaptor 10 has been assembled with junction box 80—the adaptor 10 through side wall 86 is shown in place as described above with respect to FIG. 9, but in this case, a bore has been formed in ceiling tile 74 so that the bore through the tile aligns with the bore 88 in the junction box. Adaptor 10 that extends through bore 88 is of the type of embodiment shown in FIG. 5, with a relatively larger and longer second threaded end 16. It will be appreciated that the adaptor extends through tile 74 as shown and described elsewhere

With respect to FIG. 10 a significant length of cable 38 may be coiled in junction box 80. If a user wants to increase the length of the cable below the ceiling tile, for example, to reposition the microphone that is attached to the distal end of the cable, the cap 22 on adjustment side of the adaptor—which is the side of the installation shown in FIGS. 7 and 8 and which extends through the tile is loosened and this allows the cable to be pulled downwardly—the excess cable coiled in the junction box allows the length of the cable below the tile to be increased. The cable also extends through the adaptor 10 that is positioned in wall 86, which allows a second adjustment in the length of the cable 38.

The length of the cable 38 below the ceiling tile may also be shortened by reversing the sequence described above and pushing the cable back up through the adaptor, where it bunches up in the junction box 80.

When cap 22 is tightened to fix the cable 38 relative to the main body 12, there is no air-passageway through the main body because the O-ring 40 is compressed around the cable 38 as detailed above and thereby defines an air tight seal of the bore 20. There is, therefore, a plenum seal maintained between the space under the ceiling tile and the air space above the tile. Accordingly, the adaptor 10 of the present invention is usable in situations where the cable is routed through the ceiling (or wall) where a plenum seal rating is desired.

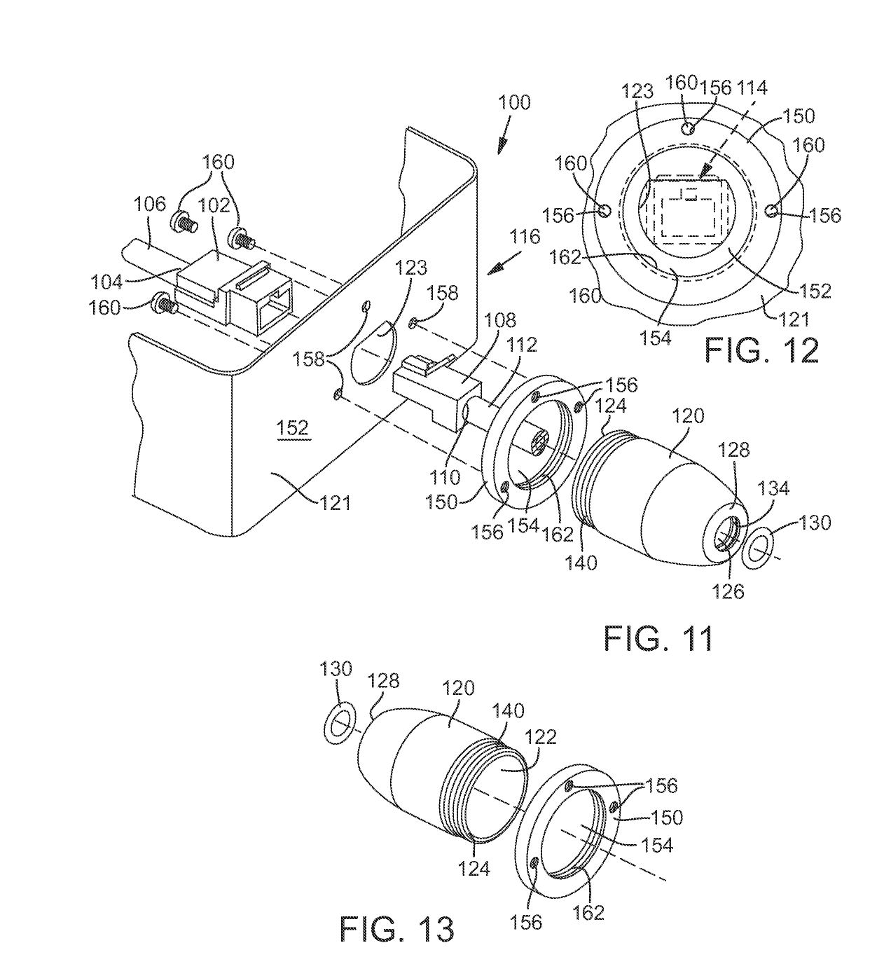

With reference now to FIGS. 11 through 15, a plenum seal apparatus 100 is detailed with respect to use with a registered jack type of cable connector. As noted above, a very common type of cabling connection that is used in a variety of settings are the “registered jack”—“RJ”—types of connectors. These connectors are standardized physical network interfaces for connecting telecommunications or data equipment such as a standard computer to a communications network interface such as a service provided by a local exchange carrier. As shown in FIG. 11, a female plug 102 is attached to an end 104 of cable 106 that extends to standard interconnections with, for instance, telecommunications connections. The male plug 108 is electrically attached to an end 110 of cable 112 that extends to, for instance, a computer (not shown) or other electronics equipment. The wiring used in cables 106 and 112, and their connections to pinouts in the female and male plugs 102 and 108 are conventional and need not be described here. The male and female plugs 102 and 108 are shown in their interconnected position in FIG. 15 and for purposes herein, the interconnected plugs are referred to as connected plug 114. A junction box 116 has a D-shaped opening 123 through which the connected plug extends to provide the electronic connection between one side of the junction box and the other. More specifically, a wall 121 of the junction box defines a barrier between adjacent spaces across which a plenum seal is to be created. It will be appreciated that the junction box 116 may be used at a wall or ceiling and the like, and that wall board or ceiling tiles may also be used. Regardless, the plenum seal apparatus 10 according to the invention is used where a plenum seal is desired between, for example, a living space on one side of the barrier defined by wall 121—the space on the right in FIG. 11, and the space on the opposite side of the wall 121—the space on the left in FIG. 11.

It will be understood there are many different standard designs for RJ connectors such as RJ11, RJ14, RJ21, RJ35, RJ45, Rj48 and numerous others. The connected plug 114 shown herein is a RJ45 connector but the RJ45 connector is used only to illustrate; it does not limit the invention.

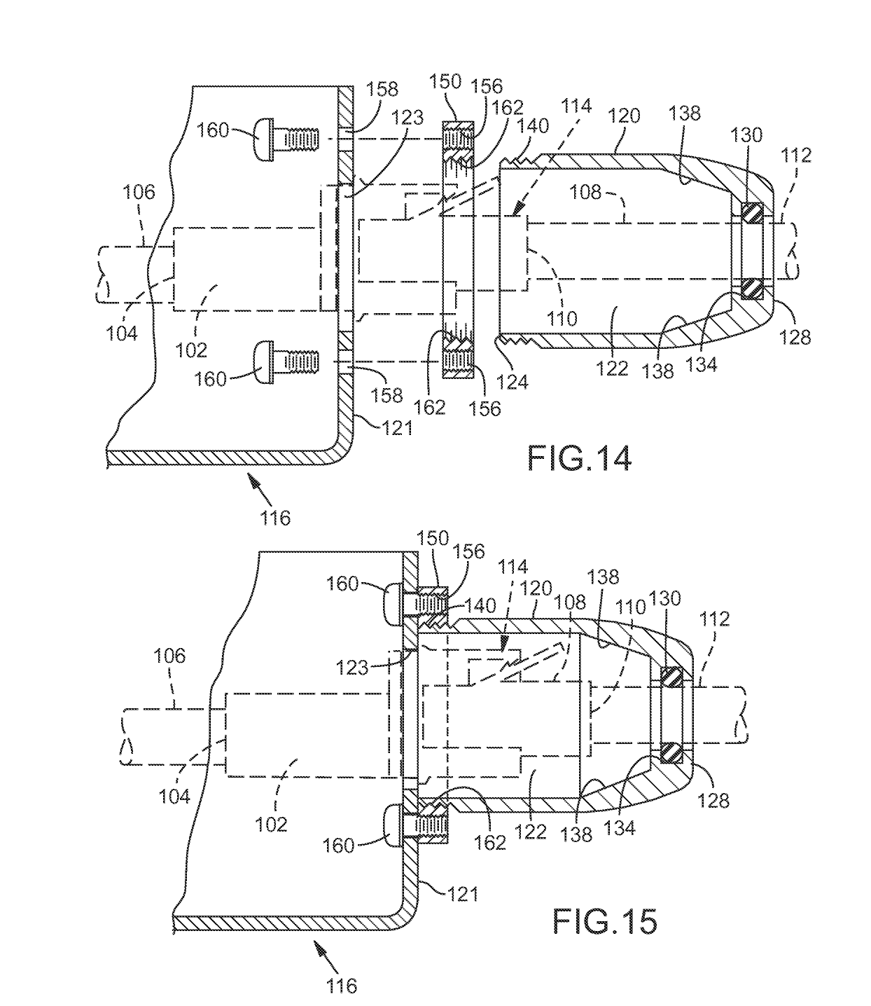

Plenum seal apparatus 100 is defined by a plenum cap 120 and a junction box adaptor 150 that is secured to junction box 116 and which serves as a base to which plenum cap 120 is attached when the unit is assembled. Each component is described separately beginning with plenum cap 120. Plenum cap 120 is an elongate, roughly bullet-shaped body having a hollow interior 122 and an open base end 124 and an opening 126 at the tip end 128 of the cap 120. The cable 112 extends through the hollow interior 122 and the opening 126 has a diameter that is slightly greater than the diameter of cable 112 so that the cable may be extended through the opening. A resilient O-ring 130 is received in a circumferential seat 134 formed in an interior shoulder 136 of cap 120 adjacent opening 126 (FIGS. 14 and 15). The diameter of O-ring 130 is less than the diameter of cable 112 so that when the O-ring is seated in circumferential seat 134 with cable 112 extending through the O-ring, the O-ring is compressed around the cable and such that air cannot flow past the O-ring. The plenum cap thus defines an air passage block to prevent air from flowing through the hollow interior 122. The compression seal established between O-ring 130 and cable 112 allows the plenum cap 120 to be slid along the cable without compromising the air-tight seal between cap and cable.

The diameter of the hollow interior 122 of plenum cap 120 increases in the direction from shoulder 136 to the base end 124 and there is thus a passageway defined through the plenum cap. As best seen in FIGS. 14 and 15, a sloped interior wall portion 138 increases the diameter of the hollow interior 122 so that the connected plug 114 is housed within a cavity defined in the hollow interior 122. The base end 124 of plenum cap 120 has external threads 140.

Junction box adapter 150 is a ring that is attached to the outer surface 152 of wall 121 of junction box 116 such that the open center 154 of adapter 150 is positioned over D-shaped opening 123. Three threaded bores 156 are spaced around the periphery of adapter 150 and bores 158 are drilled through junction box 116 around D-shaped opening 123 at equal spacing with bores 156. Three screws 160 are inserted through the bores 158 and are threaded into threaded bores 156 to secure the junction box adapter 150 to the wall 121 of the junction box with an air-tight seal. Other equivalent fasteners may be substituted for the screws 160 and sealants or a gasket may be used to enhance the air tight fit. As best seen in FIG. 12, when junction box adapter 150 is attached to junction box 116, the open center 154 of the adapter 150 leaves the D-shaped opening 123 unobstructed. The interior diameter of adapter 150 is threaded at threads 162 so that the external threads 140 at base end 124 of plenum cap 120 may be threaded onto threads 162 of adapter 150 to secure the cap to the adapter.

Assembly of plenum cap 120 with cable 112 will be evident from review of the drawings. Specifically, prior to the electrical attachment of male plug 108 to the wiring in cable 112 the end 110 of the cable is inserted through opening 126 of plenum cap 120. As noted, the diameter of O-ring 130 is slightly less than the diameter of cable 112 so as to facilitate an air-tight seal between the cable and the O-ring. As such, some force is required to push the cable through the O-ring. With the end 110 of cable 112 pushed through the O-ring the electrical connections between wiring in the cable and the corresponding pins in the male plug 108 may be made.

Junction box adapter 150 is attached to junction box 116 with screws 160 and cable 106, with female plug 102 attached to end 104, is positioned in junction box 116 near D-shaped opening 123. The male plug 108 is connected to female plug 102 as usual and plenum cap is threated onto junction box adapter 150 as best shown in FIG. 15. As the plenum cap 120 is rotated to thread it into adapter 150 the O-ring 130 slips over the outer surface of the cable, allowing relative rotation between the plenum cap and the cable. The cable is prevented from rotation by virtue of physical interference between the flattened portion of D-shaped opening 123 and the square body shape of the connected plug 114. The size of the cavity defined in hollow interior 122 of plenum cap 120 relative to the size of the connected plug may vary and the invention contemplates that some plugs 114 may be small enough that there is relative movement between the plug, the cap, and the barrier defined in this case by the wall 121. Moreover, the D-shaped opening 123 may be circular as described above with reference to, for example, bore 80. However, a plenum seal is defined once the cap 120 is secured to the adapter 150 with the O-ring in sealing contact with the cable, and as such any movement of the plug relative to the fixed structures is not of consequence and will not destroy the plenum seal. More specifically, the air tight seal between the O-ring and the cable is not hindered by either axial rotation of the cable or by longitudinal movement of the cable, relative to the cap.

Those of skill in the art will recognize that there are numerous equivalent structures to those mentioned above that may be used without changing the invention. As an example, the wall 121 that is part of junction box 116 is an example only of a barrier across which a plenum seal is to be formed. The barrier could be defined by many other structures, such as a different wall of a junction box, a plate, a wall or ceiling, or a plate that has a decorative appearance that is attached to a wall or ceiling or the like. For example, with reference to FIG. 9 and the junction box 80 illustrated in that figure, the wall of the junction box 80 that rests against the surface 82 of ceiling tile 74 could define the barrier across which the plenum seal is established with plenum seal apparatus 100.

Similarly, the threaded attachment between the plenum cap 120 and the junction box adapter 150 may be replaced with other suitable attachment structures for joining the two, such as a bayonet type of fitting or other mechanical attachment or even magnetic attachment. As another example of a structure described herein that may be readily modified, the size of the hollow interior 122 of plenum cap 120 may be modified according to the type and size of connector that will be housed in the interior.

While the present invention has been described in terms of preferred and illustrated embodiments, it will be appreciated by those of ordinary skill that the spirit and scope of the invention is not limited to those embodiments, but extend to the various modifications and equivalents as defined in the appended claims.

1. Apparatus for creating a plenum seal across a barrier between spaces and through which a cable extends through a bore, comprising:
a plenum cap having an open first end and an open opposite second end to define a passageway therethrough and an O-ring at the open first end;
an adapter attached to the barrier, said adapter having an open portion that surrounds the bore in the barrier;
wherein the cable extends through the passageway through the plenum cap and a seal is defined between the O-ring and the cable, and the cap is attached to the adapter to define a plenum seal across the barrier.

2. Apparatus according to claim 1 wherein the passageway of the plenum cap further defines a cavity sized to receive a plug interconnecting ends of the cable.

3. Apparatus according to claim 2 in which the cable is a telecommunications cable and the plug is a registered jack plug.

4. Apparatus according to claim 3 in which the plug is an RJ45 plug.

5. Apparatus according to claim 1 wherein the plenum cap has an outer surface and the outer surface is threaded at the second end, and wherein the open portion of the adapter is threaded, and the threaded outer surface of the plenum cap is engaged with the threaded open portion of the adapter.

6. Apparatus according to claim 2 wherein the passageway through the O-ring has a first diameter and the cavity has a second diameter that is greater than the first diameter.

7. Apparatus according to claim 6 in which the plenum cap has a sloped wall between the first diameter and the second diameter.

8. Apparatus according to claim 1 wherein seal between the O-ring and the cable is an air-tight seal.

9. Apparatus according to claim 8 wherein the seal between the O-ring and the cable allows for relative movement between the O-ring and the cable.

10. Apparatus for creating a plenum seal across a barrier between spaces and through which a cable extends through a bore, wherein the cable includes a connector, comprising:
a plenum cap comprising
a body having an opening at a first end;
an opening at an opposite second end;
a passageway therethrough between the first and second ends, said passageway adapted for said cable and said body defining a cavity for receiving said connector; and
a seal at the opening at the first end for engaging said cable to create an air-tight seal between the cable and the plenum cap; and
a base attached to the barrier, said base having an opening through which said cable may extend and adapted for connecting to said plenum cap.

11. Apparatus according to claim 10 in which the connector is a registered jack connector.

12. Apparatus according to claim 11 in which the connector is an RJ45 connector.

13. Apparatus according to claim 10 wherein said seal is defined by an O-ring in a circumferential seat in the body adjacent said first end.

14. Apparatus according to claim 13 wherein the seal allows for relative movement between said cable and said O-ring.

15. Apparatus according to claim 10 wherein the plenum cap is threaded onto said base.

16. A method of creating a plenum seal around a cable that extends through an opening in said barrier between adjacent spaces, comprising the steps of:
a) attaching an adapter to said barrier such that said barrier surrounds said opening through said barrier;
b) attaching a connector first part to a first end of said cable;
c) extending the first end of said cable and said connector first part through said opening;
d) extending a second end of said cable through an opening in a plenum cap, creating an air-tight seal between said plenum cap and said cable and attaching a connector second part to the second end of said cable;
c) connecting said connector first part to said connector second part;
e) attaching said plenum cap to said adapter with said connected connector first and second parts retained within said plenum cap.

17. The method according to claim 16 wherein the step of creating an air-tight seal between the plenum cap and the cable comprises compressing said cable to a resilient member in the plenum cap.

18. The method according to claim 17 including the step of creating an air-tight connection between the plenum cap and the adapter.

19. The method according to claim 18 including the step of creating an air-tight seal between the adapter and the barrier.
